(19) United States
(12) Patent Application Publication
(10) Pub. No.: US 2002/0057960 A1
(43) Pub. Date: May 16, 2002

(54) Wheelchair lift assembly having a lift arm support

(75) Inventors: Alan R. Cohn, Lockeford, CA (US); Don Morris, Conifer, CO (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Lift-U

(21) Appl. No.: 10/047,523

(22) Filed: Oct. 25, 2001

Related U.S. Application Data
(60) Provisional application No. 60/243,331, filed on Oct. 25, 2000.

(51) Int. Cl. A61G 3/08

(52) U.S. Cl. 414/546

(57) ABSTRACT

A wheelchair lift assembly having first and second attachment arm assemblies (26a and 26b) is disclosed. The first and second attachment arm assemblies extend between a reciprocating platform (24) and a lift platform (28). The lift platform is movable between at least a raised position and a lowered position. The lift platform being held in a substantially horizontal first plane as the lift platform is moved between at least the raised and lowered positions. A support device (20) coupled to one of the first and second attachment arm assemblies for supporting one of the first and second attachment arm assemblies and maintaining the lift platform in a second plane substantially parallel to the first plane if at least a portion of the other of the first and second attachment arm assemblies fail.

### CROSS-REFERENCE TO RELATED APPLICATION

This application claims the benefit of U.S. Provisional Application No. 60/243,331, filed Oct. 25, 2000, the disclosure of which is hereby expressly incorporated by reference.

### FIELD OF THE INVENTION

The present invention relates generally to wheelchair lifts and, more particularly, to a support assembly for a lift arm of a motor vehicle wheelchair lift.

### BACKGROUND OF THE INVENTION

The Americans with Disabilities Act (ADA) requires the removal of physical obstacles to those who are physically challenged. Included within the scope of the ADA are motor vehicles, such as trains and buses. Specifically, new, used or remanufactured buses shall comply with the applicable provisions of the statute. One such provision requires that deployed platforms, when occupied, shall prevent the platform from dropping an occupant in the event of a single failure of any load-carrying component. Thus, the ADA mandates that all load carrying components of a wheelchair lift cannot have single points of failure.

Currently, there are a wide variety of wheelchair lifts available for motor vehicles. One such lift is adapted to be reciprocally mounted within a luggage compartment or stairwell of a bus or train. Such a lift includes a reciprocating platform mounted within the vehicle and a lift platform selectively actuatable between at least a raised and lowered position. The lift platform is hingedly attached to the reciprocating platform by two sets of hinge arm assemblies. The hinge arm assemblies are located on opposite sides of the lift platform and include a support arm and a balance arm. One end of the support and balance arms of each hinge arm assembly is pinned to opposite sides of the lift platform, while the other ends of the hinge arm assemblies are pinned to opposite sides of the reciprocating platform. As attached, the hinge arm assemblies reciprocate the lift platform between the raised position and the lowered position. Although such a lift is effective at accommodating wheelchair access into and out of a motor vehicle, it is not without its problems.

One of the major problems associated with currently available wheelchair lifts is the design of the hinge arm assemblies. Specifically, if one of the pins attaching the support arm to the lift platform fails, the lift platform would pivot about the pin attaching the balance arm to the lift platform, thereby potentially injuring a person located on the lift platform. This is due in part to the attachment location of the hinge arm assembly to the lift platform relative to the center of gravity of the lift platform.

Such a wheelchair lift is not only dangerous, it also fails to comply with the prohibition of the ADA regarding single point failure of any load carrying component. Further, such wheelchair lifts are also not in compliance with recent proposed revisions to the ADA establishing even more stringent requirements with at least regard to the single point of failure provision. Moreover, the proposed revisions to the ADA are also applicable to existing wheelchair lifts. Therefore, existing wheelchair lifts must be retrofitted.

For at least the foregoing reasons, there exists a need for a wheelchair lift that includes a redundant support in the event of a failure of a portion of the lift, wherein the redundant support complies with the ADA requirements, is economical to install and maintain, and may be easily retrofitted into existing wheelchair lifts.

### SUMMARY OF THE INVENTION

In accordance with certain embodiments of the present invention, a wheelchair lift assembly is provided. The wheelchair lift assembly includes first and second attachment arm assemblies extending between a reciprocating platform and a lift platform. The lift platform is movable between at least a raised position and a lowered position. The lift platform is held in a substantially horizontal first plane as the lift platform is moved between at least the raised and lowered positions. The wheelchair lift assembly further includes a support device coupled to one of the first and second attachment arm assemblies, where the support device supports one of the first and attachment arm assemblies and maintains the lift platform in a second plane substantially parallel to the first plane if at least a portion of the other of the first and second attachment arm assembly fails.

In accordance with further aspects of this invention, the support device includes a bracket extending between an upper arm and a lower arm of one of either the first or second attachment arm assembly. In another aspect of this invention, the support device includes a second bracket extending between an upper arm and a lower arm of the other of the first or second attachment arm assembly.

In accordance with still yet another aspect of this invention, the support device includes a U-shaped first bracket pinned to one of an upper or lower arm of the first or second attachment arm assembly. In accordance with still yet another aspect of this invention, the support device includes a U-shaped bracket pinned to one of an upper or lower arm of each of the first and second attachment arm assemblies.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is a perspective view of a wheelchair lift assembly having a support assembly formed in accordance with one embodiment of the present invention;

FIG. 2 is a side planar view of a wheelchair lift having a support assembly formed in accordance with one embodiment of the present invention;

FIG. 3 is a cross sectional view of the support assembly formed in accordance with one embodiment of the present invention taken substantially through Section 3-3 of FIG. 2;

FIG. 4 is a partial perspective view of a wheelchair lift having a support assembly formed in accordance with another embodiment of the present invention;

FIG. 5 is a cross sectional end view of the support assembly of FIG. 4;

FIG. 6 is a partial perspective view of a wheelchair lift having a support assembly formed in accordance with yet another embodiment of the present invention; and

FIG. 7 is a cross-sectional view of the support assembly formed in accordance with the embodiment of FIG. 6 and taken substantially through Section 7-7 of FIG. 6.

### DETAILED DESCRIPTION OF THE PREFERRED EMBODIMENT

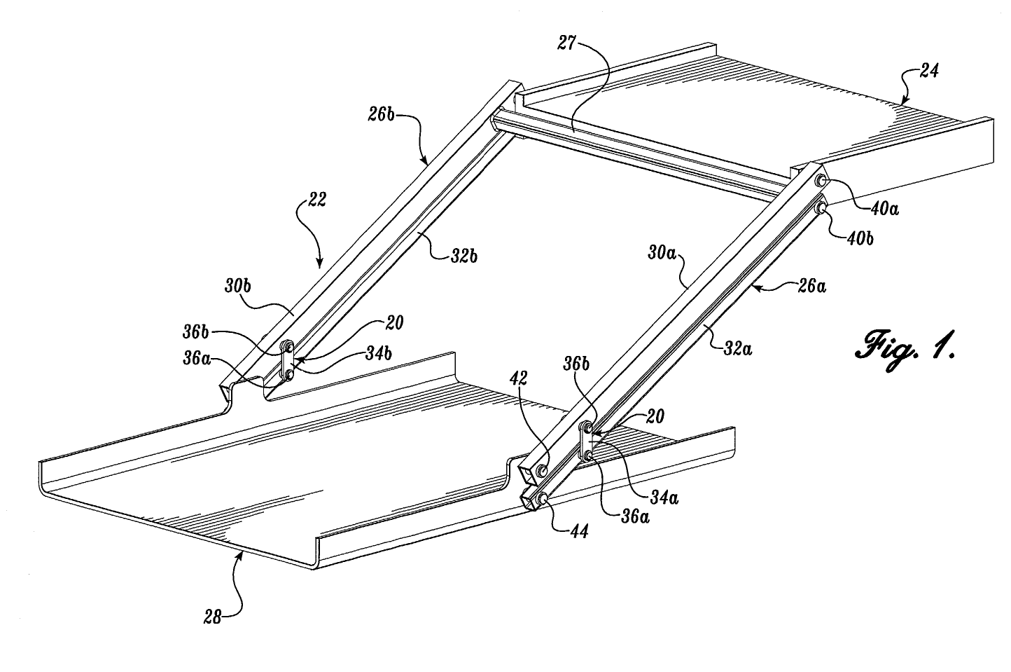

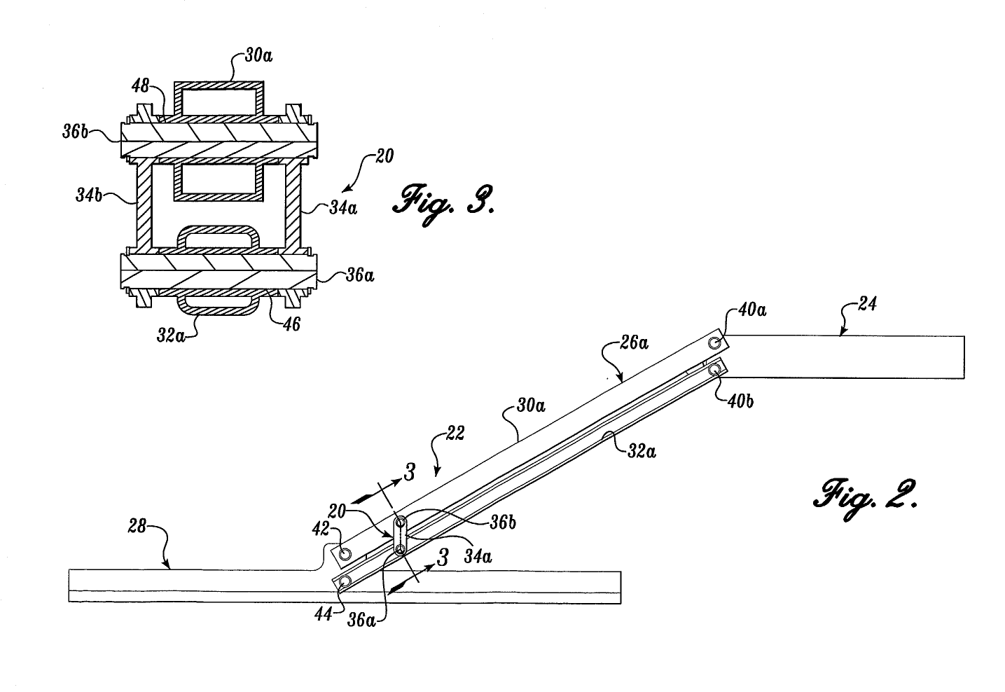

FIGS. 1 and 2 illustrates one embodiment of a support assembly 20 formed in accordance with the present invention. The support assembly 20 is designed to be used with a wheelchair lift 22, such as the wheelchair lift disclosed in U.S. Pat. No. 5,110,252, issued to Aoki, the disclosure of which is hereby expressly incorporated by reference. For clarity, the vehicle to which the wheelchair lift 22 can be installed has not been illustrated. Further, although the support assembly 20 is illustrated as fastened to a reciprocating platform lift, other types of wheelchair lifts, such as wheelchair lifts mounted in a stairwell of a vehicle, are also within the scope of the present invention.

The wheelchair lift 22 includes a reciprocating platform 24, a pair of attachment arm assemblies 26a and 26b, and a lift platform 28. The reciprocating platform 24 is slidably attached to a pair of support rails (not shown) located within a vehicle (not shown). The support rails are in turn fastened to a support structure, such as a passenger floor or stairwell, of the vehicle by well known fasteners, such as bolts.

The reciprocating platform 24 is adapted to slide within the support rails between a stowed position, wherein the wheelchair lift 22 is received within a stowage compartment located within the vehicle, and a deployed position, wherein the lift platform 28 is adapted to receive a wheelchair, as is described in greater detail below.

The attachment arm assemblies 26a and 26b are hingedly attached to one end of the reciprocating platform 24. As attached, the attachment arm assemblies are able to reciprocate the lift platform 28 between a lowered position, an intermediate position, and a raised position, as is well known in the art. In the lowered position, the lift platform 28 is located adjacent a curbside or loading platform. In this position, a wheelchair may be rolled on or off of the lift platform 28. In the intermediate position, the lift platform 28 is substantially level with the reciprocating platform 24, to permit withdrawal of the wheelchair lift 22 into the stowage compartment. Finally, in the raised position, the lift platform 28 is displaced upwardly to position the lift platform 28 adjacent an entryway of the motor vehicle.

Extending between the attachment arm assemblies 26a and 26b is a torsion tube 27. The torsion tube 27 is welded on each end to the attachment arm assemblies 26a and 26b. As well known in the art, the torsion tube 27 actuates the lift platform 28 between the lowered position, intermediate position and the raised position by applying torque to the attachment arm assemblies 26a and 26b.

Each attachment arm assembly 26a and 26b includes a support arm 30a and 30b and a balance arm 32a and 32b. Each attachment arm assembly 26a and 26b is identical. Therefore, for clarity, only one attachment arm assembly shall be described in greater detail. However, it should be apparent that the description for one attachment arm assembly is applicable to the other assembly.

One end of the support arm 30a and balance arm 32a is coupled to opposite sides of one end of the reciprocating platform 24 by a well known attachment pin assembly 40a and 40b, such as a trunnion or cantilevered pin. The other end of the support arm 30a and balance arm 32a is similarly fastened to opposite sides of the lift platform 28 by a well known support arm pin 42 and balance arm pin 44. As coupled to both the reciprocating platform 24 and lift platform 28, the attachment arm assemblies 26a and 26b permit hinged movement of the lift platform 28 relative to the reciprocating platform 24.

Referring now to FIGS. 1 and 3, the support assembly 20 will now be described in greater detail. Although a single support assembly 20 is illustrated as attached to each one of the attachment arm assemblies 26a and 26b, the invention is not intended to be so limited. As a non limiting example, two or more support assemblies may be attached to each attachment arm assembly 26a and 26b. Further, each support assembly 20 is identical and, therefore, only one support assembly will be described in greater detail. However, it should be apparent that the description for one support assembly 20 is applicable to the other.

The support assembly 20 includes first and second plates 34a and 34b and a pair of support pins 36a and 36b. Each plate 34a and 34b is suitably a rectangular member formed from a high strength material, such as steel. The plates 34a and 34b are fastened to opposite sides of the support arm 30a and balance arm 32a by the strap pins 36a and 36b. As seen best by referring to FIG. 3, the first strap pin 36a extends through one end of the first plate 34a, through a correspondingly located bore 46 extending laterally through the balance arm 32a, and through the second plate 32b. The second strap pin 36b extends through the first plate 34a, through a bore 48 extending laterally through the support arm 30a, and through the second plate 34b. Thus, as attached, the support arm 30a and balance arm 32a are sandwiched between the first and second plates 34a and 34b of the support assembly 20.

In operation, the lift platform 28 is supported by the support arms 30a and 30b. As noted above, the connection between the lift platform 28 and the support arms 30a and 30b is achieved by the support arm pin 42. The lift platform 28 is maintained in a substantially horizontal position throughout its range of motion by the connection between the balance arms 32a and 32b through the balance arm pin 44. It should be apparent that the phrase “substantially horizontal position” includes the normal operating range of a wheelchair lift within the scope of this disclosure. Thus, such normal operating ranges are within the scope of all embodiments of the present invention.

In the event of a failure of one of the balance arm pins 44, the lift platform 28 is maintained level by the balance arm located on the opposite side of the lift platform 28. Although the lift platform 28 may drop slightly from its originally supported position, the support assembly 20 maintains the lift platform 28 in a plane substantially parallel to its original horizontal plane. As an example, in the event of failure of the balance arm pin 44 connecting the balance arm 32a to the lift platform 28, the other balance arm 32b maintains the level positioning of the lift platform 28.

In the event of a failure of one of the support arm pins 42, the lift platform load is transferred to the balance arms 32a and 32b by the support assembly 20. The first and second plates 34a and 34b of each support assembly 20 transfer loads associated with the support arm to the corresponding balance arm, while maintaining the level positioning of the lift platform 28. Thus, each support assembly 20 acts as a load transfer device, whereby in the event of a failure of one of the load bearing support arm pins, the load associated with the support arm is transferred to the balance arm by one or more of the support assemblies.

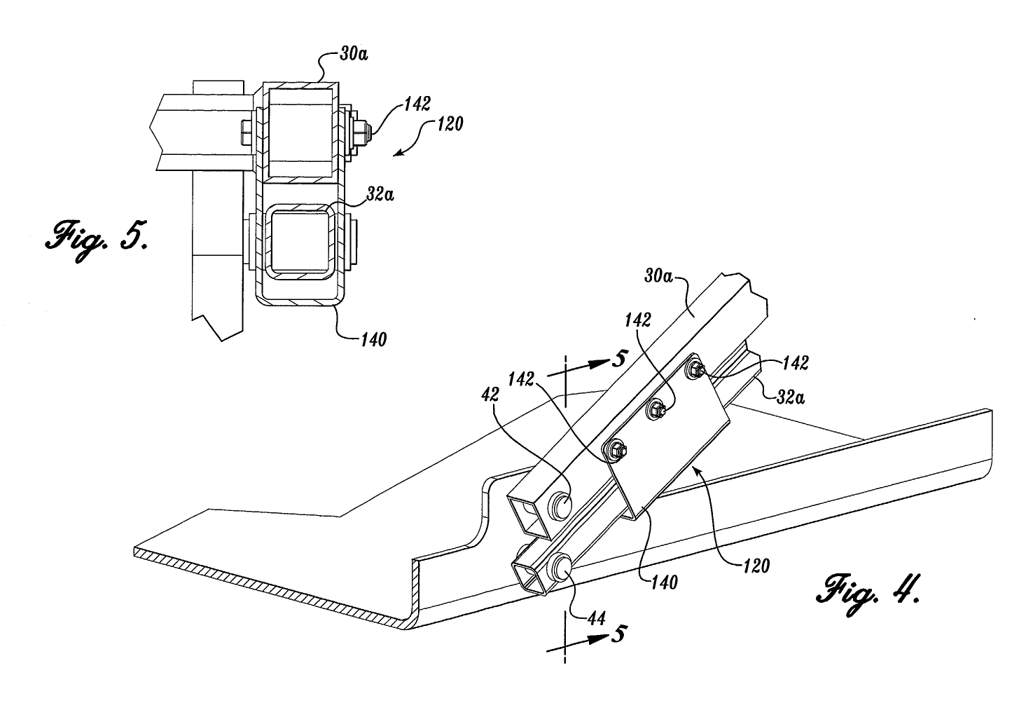

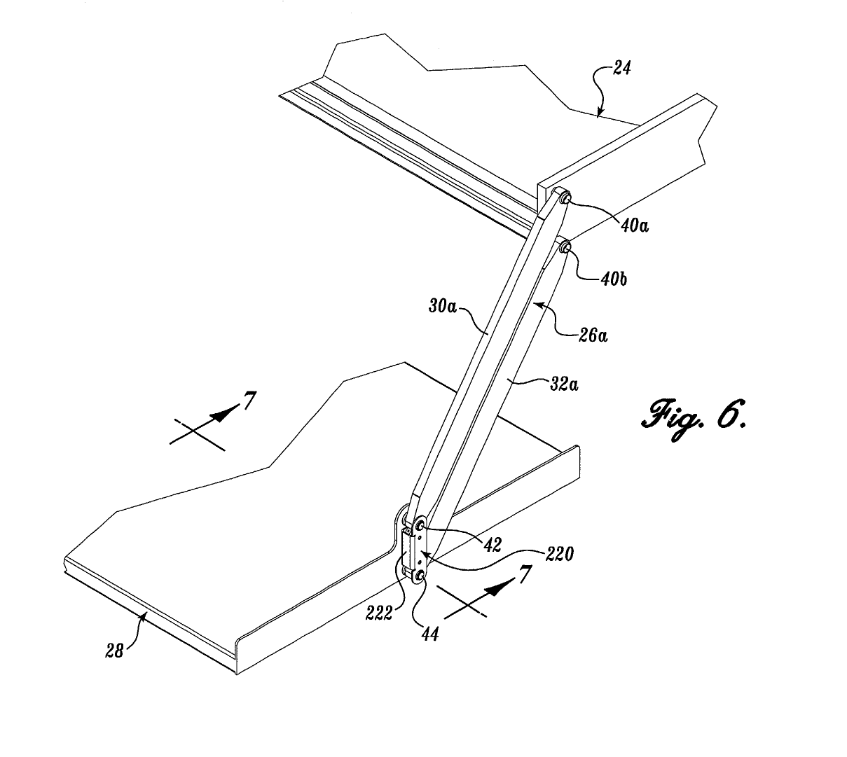

Referring now to FIGS. 4 and 5, a support assembly 120 formed in accordance with another embodiment of the present invention will now be described in greater detail. The support assembly 120 of the second embodiment is identical in materials and operation to the first embodiment described above with the following exception. The support assembly 120 includes a U-shape saddle strap 140 formed from a high strength material, such as steel. The saddle strap 140 extends from one side of the support arm 30a to the other side of the support arm 30a to cradle the balance arm 32a within the saddle strap 140. The saddle strap 140 is fastened to the support arm 30a by a plurality of fasteners 142, such as bolts, extending through opposite sides of the saddle strap 140 and the support arm 30a.

In operation, in the event that the support arm pin 42 fails, the load of the support arm 30a is transferred to the balance arm 32a by the saddle strap 140. In the event support arm pin 42 fails, the support arm 30a or 30b is held in position by the torque tube 27. Because the saddle strap 140 is fastened to the support arm 30a, the saddle strap 140 is also held in position. However, because of the failed support arm pin 42, the lift platform 28 drops slightly until the balance arm 32a is received within the saddle strap 140. As a result, load is transferred to the balance arm 32a.

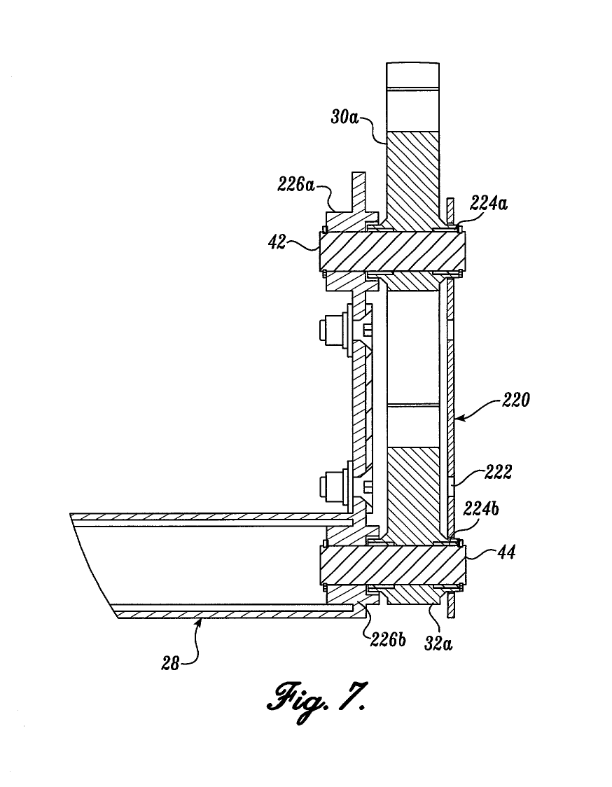

Referring now to FIGS. 6 and 7, a support assembly 220 formed in accordance with yet another embodiment of the present invention will now be described in greater detail. The support assembly 220 is identical in materials and operation to the embodiments described above with the following exceptions. As seen best by referring to FIG. 6, the support assembly 220 includes a U-shaped retaining plate 222 extending between the support arm pin 42 and balance arm pin 44. Although the retaining plate 222 is suitably U-shaped in configuration, other shapes, such as two plates pinned to the outboard and inboard facing sides of the support arm 30a and balance arm 32a, are also within the scope of the present invention.

As seen best by referring to FIG. 7, the support arm pin 42 and balance arm pin 44 are seated within the support arm 30a and balance arm 32a, respectively, on bushing housings 224a and 224b. The retaining plate 222 extends around one end of the support arm 30a and balance arm 32a and is coupled to each arm by the pins 42 and 44.

During normal operation, the support arm 30a and balance arm 32a are attached to the lift platform 28 using the support arm pin 42 and balance arm pin 44. The support arm pin 42 and balance arm pin 44 are held in place by retaining rings (not shown) located on both ends. In the event of a pin breakage or displacement, the retaining plate 222 holds one of either the support arm 30a or balance arm 32a in place. The outer surface of the bushing housing 224a or 224b is trapped in place by the inner surface of shaft housing 226a or 226b, thereby constraining the system in the event of a pin failure. Thus, the contact between the inner surface of the shaft housing and the outer surface of the bushing housing are redundant to the function normally provided by the support arm pin 42 or balance arm pin 44.

While the preferred embodiment of the invention has been illustrated and described, it will be appreciated that various changes can be made therein without departing from the spirit and scope of the invention.

Although each of the foregoing embodiments have been described, it should be apparent that variations of embodiments are also contemplated and, therefore, are within the scope of the present invention. As a non-limiting example, the support assembly may be attached to one of either the support arm or balance arm, both of the support and balance arms, and/or both ends of the support and balance arms.

The embodiments of the invention in which an exclusive property or privilege is claimed are defined as follows:

1. A wheelchair lift assembly comprising:
(a) first and second attachment arm assemblies extending between a reciprocating platform and a lift platform, the lift platform movable between at least a raised position and a lowered position, the lift platform being held in a substantially horizontal first plane as the lift platform is moved between at least the raised and lowered positions; and
(b) a support device coupled to one of the first and second attachment arm assemblies, the support device supporting one of the first and second attachment arm assemblies and maintaining the lift platform in a second plane substantially parallel to the first plane if at least a portion the other of the first and second attachment arm assemblies fails.

2. The wheelchair lift assembly of claim 1, wherein the support device comprising a bracket extending between an upper arm and a lower arm of one of either the first or second attachment arm assembly.

3. The wheelchair lift assembly of claim 2, wherein the support device comprising a second bracket extending between an upper arm and a lower arm of the other of the first or second attachment arm assembly.

4. The wheelchair lift assembly of claim 3, wherein the support device is located at one end of the first and second attachment arm assemblies.

5. The wheelchair lift assembly of claim 3, wherein the support device is located between first and second ends of the first and second attachment arm assemblies.

6. The wheelchair lift assembly of claim 1, wherein the support device comprising a U-shaped first bracket pinned to one of an upper or lower arm of the first or second attachment arm assembly.

7. The wheelchair lift assembly of claim 1, wherein the support device comprising a U-shaped bracket pinned to one of an upper or lower arm of each of the first and second attachment arm assemblies.

8. The wheelchair lift assembly of claim 7, wherein the support device is located at one end of the first and second attachment arm assemblies.

9. The wheelchair lift assembly of claim 8, wherein the support device is attached to the upper and lower arms.

10. The wheelchair lift assembly of claim 7, wherein the support device is located between first and second ends of the first and second attachment arm assemblies.

11. A wheelchair lift assembly comprising:
(a) first and second attachment arm assemblies extending between a reciprocating platform and a lift platform, the lift platform movable between at least a raised position and a lowered position, the lift platform being held in a substantially horizontal plane as the lift platform is moved between at least the raised and lowered positions; and
(b) support means extending between a portion of one of the first and second attachment arm assemblies for supporting one of the first and second attachment arm assemblies and maintaining the lift platform in a plane substantially parallel to horizontal plane if at least a portion the other of the first and second attachment arm assemblies fails.

12. The wheelchair lift assembly of claim 11, wherein the support means comprising a bracket extending between an upper arm and a lower arm of one of either the first or second attachment arm assembly.

13. The wheelchair lift assembly of claim 11, wherein the support means comprising a U-shaped bracket pinned to one of either an upper arm or a lower arm of one of either the first or second attachment arm assembly.

14. The wheelchair lift assembly of claim 12, wherein the support means is located at one end of the first and second attachment arm assemblies.

15. A wheelchair lift assembly, comprising:
(a) a lift platform;
(b) a reciprocating assembly extending between the lift platform and a reciprocating platform for reciprocating the lift platform between raised and lowered positions, the lift platform being held in a substantially horizontal first plane as the reciprocating assembly reciprocates the lift platform between the raised and lowered positions;
(c) a support apparatus coupled to the reciprocating assembly for supporting reciprocating assembly and maintaining the lift platform in a second plane substantially parallel to first plane if at least a portion the reciprocating assembly fails.

16. The wheelchair lift assembly of claim 15, wherein the support apparatus comprising a bracket extending between a portion of the reciprocating assembly.

17. The wheelchair lift assembly of claim 16, wherein the support apparatus comprising second bracket extending between a portion of the reciprocating assembly.

18. The wheelchair lift assembly of claim 16, wherein the support apparatus is located at one end of the reciprocating assembly.

19. The wheelchair lift assembly of claim 15, wherein the support apparatus comprising a U-shaped first bracket pinned to a portion of the reciprocating assembly.

20. The wheelchair lift assembly of claim 19, wherein the support apparatus comprising a U-shaped second bracket pinned to a portion of the reciprocating assembly.

21. The wheelchair lift assembly of claim 15, wherein the reciprocating assembly includes first and second attachment arm assemblies, each attachment arm assembly having an upper arm and a lower arm to reciprocate the lift platform between the raised and lowered positions.

22. The wheelchair lift assembly of claim 21, wherein the support apparatus comprising a bracket extending between the upper and lower arms of one of either the first or second attachment arm assembly.

23. The wheelchair lift assembly of claim 21, wherein the support apparatus comprising a U-shaped bracket pinned to one of either the upper or lower arms of one of either the first or second attachment arm assemblies.
